(19) United States
(12) Patent Application Publication
(10) Pub. No.: US 2023/0225371 A1
(43) Pub. Date: Jul. 20, 2023

(54) Feed Additive, Method of Preparation, and Use in Order to Improve the Zootechnical Performance of a Ruminant

(71) Applicant: PANCOSMA SA, Le Grand-Saconnex (CH)

(72) Inventors: David Bravo, Yverdon-Les-Bains (CH); Emma Wall, Vannes (FR)

(21) Appl. No.: 18/123,742

(22) Filed: Mar. 20, 2023

Related U.S. Application Data
(62) Division of application No. 17/476,164, filed on Sep. 15, 2021.
Application No. 17/476,164 is a division of application No. 15/778,185, filed on May 22, 2018, now abandoned.

(30) Foreign Application Priority Data
Nov. 25, 2015 (FR) 1502465

(51) Int. Cl. A23K 40/35; A23K 50/10; A23K 20/10; A23K 20/158

(52) U.S. Cl. CPC A23K 40/35; A23K 50/10; A23K 20/10; A23K 20/158; A23K 20/189

(57) ABSTRACT

The invention relates to a feed additive comprising at least one nutrient, which non-nutrient is incorporated in a matrix, the entirety being encapsulated by a coating comprising at least a plant material whose saponification number is greater than 180.

The invention also deals with a method for preparing a feed additive.

Finally, the invention also relates to the use of the feed additive to improve the zootechnical performance of a ruminant.

The invention relates to a feed additive and a method for preparing a feed additive.

This feed additive is intended, in particular, to be used to improve the zootechnical performance of a ruminant.

### BACKGROUND OF THE INVENTION

The nutrition and feeding of ruminant animals are based on the recognition of rumen symbiosis. The rumen, situated before the stomach and intestine, houses a microbial ecosystem. With this ecosystem, the ruminant animal uses substrates that it otherwise would not be able to use. The most common example is a ruminant's use of dietary fiber. Its rumen ecosystem digests the fiber and then ferments it. Fermentation releases fermentation byproducts, volatile fatty acids, which are absorbed by the ruminant and used as an energy substrate. For example, it is estimated that 60% of the energy that a dairy cow uses has a microbial origin. By multiplying, the rumen ecosystem also produces microbial proteins. When dissipated from the rumen, the bacteria are digested and then absorbed by the lower portion of the digestive trace, starting with the intestine.

With regard to the nutrition and feeding of ruminants, we generally talk in terms of optimizing rumen fermentation. Work has shown that it may be nutritionally beneficial to provide sources of nutrients that can bypass the digestion and rumen fermentation processes and be absorbed by the intestine. This is true of nutrients like amino acids.

### SUMMARY OF THE INVENTION

The main goal of the invention is to propose a feed additive and a method for preparing a feed additive.

This feed additive is intended to be used to improve the zootechnical performance of a ruminant.

More specifically, the feed additive, which is comprised of a non-nutrient or a combination of non-nutrients, or which contains at least one non-nutrient or a combination of non-nutrients, and which is capable of reaching a certain proportion of the abomasum or rennet stomach, is introduced into the ruminant's abomasum/rennet stomach, past the rumen.

The introduction can be carried out by passing the feed additive through the rumen.

The non-nutrient(s) is/are preferably incorporated in a matrix, the entirety of which is encapsulated by a coating comprising at least one plant-based material whose saponification number is greater than 180, ideally greater than 190.

By non-nutrient, this means a compound (a molecule or living organism) that has no nutritional effect by itself. This means that it is not vital for the animal consuming it. However, the non-nutrient is capable of affecting the animal's metabolism, endocrinology, and/or immunity, either directly (e.g., by the activation of a membrane receptor) or indirectly (e.g., by modulating the composition of its intestinal flora or the viscosity of the feed or by promoting access to certain nutrients in the digestive tract).

The inventors have surprisingly discovered that it was possible to affect a ruminant's metabolism and immunity and thereby improve its zootechnical performance, by sending non-nutrients not to the rumen, where they will be broken down and used, but past the rumen.

According to a preferred embodiment of the invention, the non-nutrient(s) is(are) ingested by the ruminant in the form of a feed additive, with the non-nutrient(s) being comprised of particles and encapsulated in a special manner, namely, in a resistant coating for passage through the rumen. The non-nutrient(s) may thus be released past the rumen, in the ruminant's abomasum or intestine.

According to another aspect, the invention deals with a method for preparing a feed additive, comprising the following steps:
a) at least one non-nutrient, in the form of particles, is chosen;
b) at least one compound forming a matrix is optionally chosen for the non-nutrient(s), and the compound(s) is(are) incorporated into the matrix in a manner so as to obtain the particles;
c) it is assessed whether the non-nutrient is broken down in the rumen when it is left unprotected;
d) if the non-nutrient is broken down beyond an initial threshold, go to point f);
e) if the non-nutrient is not broken down beyond an initial threshold, it is adopted, with its optional matrix, and we go to point l);
f) at least one compound forming a matrix is optionally chosen for the non-nutrient(s), and the non-nutrient(s) is(are) incorporated into the matrix in a manner so as to obtain the particles;
g) at least one coating compound is chosen;
h) the non-nutrient(s) and the optional compounds forming a matrix is(are) coated through the coating compounds and in a manner so as to obtain particles;
i) the instability of the non-nutrients contained in these particles in the rumen is measured;
j) if the instability is greater than a second threshold, return to point f);
k) if the instability is less than or equal to the second threshold, the formulation of coated particles is adopted; then
l) the feed additive is prepared according to what was previously adopted.

The invention also relates to the use of the feed additive to improve the zootechnical performance of ruminants, specifically, at least one of the following performances: milk production, milk quality, altered milk composition, altered feed consumption, altered eating behavior, improved average weight gain, increased food efficiency, improved insulin sensitivity of the digestive system, improved digestive health, and improved immunity.

Other characteristics and advantages of the invention will now be described in detail in the following description, which refers to FIG. 1 that schematically shows the comparison of improvements in milk production provided by the supplementation of feed additives NR/NN1 and NR/NN2, relative to a control.

### BRIEF DESCRIPTION OF THE FIGURES

FIG. 1 schematically shows the comparison of improvements in milk production provided by the supplementation of feed additives NR/NN1 and NR/NN2, relative to a control.

### DETAILED DESCRIPTION OF THE INVENTION

The term “past the rumen” refers to the direction of food transit inside the ruminant's digestive system. For example, the stomach (also called the abomasum) is situated past the rumen, and the intestine is situated past the stomach.

According to the invention, the non-nutrient can be of a highly varied nature. It may be plant extracts and/or their active compounds (of a natural, partially natural, or fully synthetic origin), flavors, prebiotics, probiotics, sweetening molecules, enzymes (particularly from the family of amylases), non-nutritional forms of metals, or minerals.

According to a preferred embodiment of the invention, the non-nutrient is oleoresin capsicum (which includes capsaicinoids, capsaicin, and dihydrocapsaicin).

The non-nutrient(s) can also be incorporated in a matrix forming a product core that can be coated a second time or a full product. The matrix can comprise at least one compound selected between maltodextrin, native or modified starch, gum arabic, guar gum, lecithin, alginic acid or its derivatives, agar, carob bean gum, xanthan gum, sorbitol or its derivatives, mannitol, glycerol, pectin, alginate, carrageenan, cellulose or one of its derivatives, saponin, hydrogenated fat, fatty acid glyceride or one of its derivatives, hydrogenated rapeseed oil, palm oil, soybean oil, palm oil, peanut oil, rice bran oil, cottonseed oil, sunflower oil, or safflower oil. Of course, a mixture of at least two of these compounds can be used, in any proportion.

In the presence of a matrix, the feed additive according to the invention normally comprises 0.0001 to 99.99% non-nutrients by weight, with the remainder being provided by the matrix, up to 100%.

If the non-nutrient is not included in a matrix and is coated, it may preexist in the form of a powder and then represents 100% of the core. If the non-nutrient is a liquid product, it may have been adsorbed on silica. The non-nutrient can then represent between 0.0001 and 65% of the core.

If the non-nutrient is included in a matrix and the entirety is coated, preferably 85% (by weight) of the non-nutrient particles+matrix+coating have a size of 400 to 1600 microns.

The feed additive according to the invention generally is in the form of particles or granules. If the non-nutrient is included in a matrix, the obtained product generally has, with 85% particles, a size of between 400 and 1500 micrometers. If the non-nutrient is presented in the form of a fine powder (without a matrix) that is coated, the obtained product (coating+non-nutrient) generally has, with 85% particles, a size of between 50 and 750 micrometers. If the non-nutrient is adsorbed on silica or silicon dioxide, the obtained product has a size of between 50 and 800 micrometers.

According to a preferred embodiment of the invention, the feed additive is ingested by the ruminant, with the non-nutrients being specially encapsulated, namely, in a resistant coating for passage through the rumen.

The coating may be comprised of a material consisting of a compound from the list provided above for the matrix or a mixture of at least two of these compounds, in any proportion.

Preferably, palm oil is used as a coating.

In case of encapsulation, the feed additive is normally comprised of:

0.5% to 70% core, by weight;

coating up to the full 100%.

The additive according to the invention preferably comprises at least 5% and at most 70% non-nutrients, by weight.

Preparation of the Feed Additive by a Preferred Embodiment of the Invention

By formulation, this means the type of non-nutrient or compound, any matrix, and the coating, as well as the proportions of these compounds in the feed additive. This feed additive is preferably prepared in advance according to the following method:
Point a). At least one non-nutrient is chosen;
Point b). It is assessed whether the non-nutrient is broken down in the rumen when it is left unprotected.

The method used here is described in the section below, entitled “Methodological Point on Breakdown in the Rumen” and named method I. This method results in the calculation of the DRNN-P parameter, which describes the disappearance of a non-nutrient in the rumen when it is pure.
Point c). The DRNN-P parameter makes it possible to determine whether the non-nutrient is naturally protected from breakdown in the rumen. The DRNN-P threshold beyond which the non-nutrient is considered to have broken down, called the first threshold, is preferably 40%, and specifically 30%. If this first threshold is passed, this means that the portion of non-nutrient broken down in the rumen is too high, so we go to point e).
Point d). If the non-nutrient is not broken down (DRNN-P below the first threshold), then the procedure is stopped, and the product is adopted as is.
Point e). At least one compound forming a matrix is chosen for the non-nutrient(s).
Point f). At least one coating compound is chosen.
Point g). The non-nutrient(s) and the optional compounds forming a matrix is(are) coated through the coating compounds and in a manner so as to obtain particles.
Point h). The stability of the non-nutrients contained in these particles in a rumen is measured. The method used here is described in the section below, entitled “Methodological Point on Breakdown in the Rumen” and named method II. This method makes it possible to calculate a DRNN-E parameter that describes the disappearance of particles comprised of non-nutrient(s) and any coated matrix in the rumen.
Point i). The DRNN-E threshold below which the non-nutrient is protected, called the second threshold, is preferably 60%. If the obtained DRNN-E result exceeds this second threshold, it is considered that the product is too broken down, and we return to point e).
Point j). If the DRNN-E threshold is less than or equal to the second threshold, the formulation of coated particles is adopted for preparing particles to be used as a feed additive.

### Methodological Point on Breakdown in the Rumen

### Method I: Measurement of a Non-Nutrient's Breakdown in the Rumen

Five Holstein cows with a 10 cm cannula penetrating the rumen were used for the experiment. Cr-EDTA is used as a marker for the transit of rumen fluid. When the animals were fed, 5 kg of rumen contents was collected through the cannula, mixed with given quantities of the non-nutrient in question and Cr-EDTA and then reintroduced into the rumen.

Samples of rumen contents were collected in five parts of the rumen (ventral, dorsal, reticulum, and two from the feed material present in the rumen) just after the reintroduction of the rumen contents (t=0 collected as a control), after 30 minutes, and after 1, 2, 6, 12, and 24 hours. The collected samples were frozen at −20° C., lyophilized, crushed to a size of 1 mm, and analyzed for Cr content using UPLC-MS/MS with a triple quadrupole mass spectrum (Water Xevo, Waters Corporation, Midford, Mass.). The non-nutrient content was analyzed with an appropriate method.

The residual chromium or non-nutrient contents were used in the nonlinear model, with the following equation: Y=Y₀+a×exp[−B*x]; where Y is the residual chromium or non-nutrient content, and X is time. For the chromium or non-nutrient, this equation produces a parameter B that is the disappearance rate of the chromium in the rumen (B/chromium) or the disappearance rate of the non-nutrient in the rumen (B/non-nutrient).

The breakdown percentage in the rumen for the non-nutrient (DRNN-P) is calculated as follows:

DRNN-P=100−(B/chromium÷B/non-nutrient)×100

### Method II: Measurement of the Release of Non-Nutrients Contained in an Additive in the Rumen

Three Holstein cows with rumen cannulas were used for the experiment. Polyester bags (5×10 cm, porosity of 50 micrometers, Ankom Technology, Macedon, N.Y.) containing 5 g of the product containing the non-nutrient in each bag were incubated in triplicate in each of the cows for 0, 1, 3, 6, and 12 hours. The bags were introduced into the rumen sequentially and then taken out simultaneously.

After incubation, the bags were washed with cold water than then lyophilized. The residue was analyzed for their active content using UPLC-MS/MS with a triple quadrupole mass spectrum (Waters Xevo, Waters Corporation, Midford, Mass.).

The disappearance rate of the non-nutrient of an encapsulated product (DRNN-E) was calculated based on the values obtained after 6 hours of incubation, using the following equation:

DRNN-E=(non-nutrient in the product at the start−non-nutrient in the product residue at 6 hours)÷(non-nutrient in the product at the start)×100

Additional Information

Plant extracts contain chemical substances that are naturally present in plants. For animals, these plant extracts can be non-nutrients. They are known for having antibacterial, antifungal, and antimicrobial properties, which are well described in the pharmacopoeia.

Examples of plant extracts or their active compounds include anethole, oleoresin capsicum (which includes capsaicinoids, capsaicin, and dihydrocapsaicin), vanillin, cinnamaldehyde, carvacrol, eugenol, garlic extract, thiosulfinate or an alkyl thiosulfonate such as propyl, garlic tincture, ginger oleoresin, ginger essential oil, gingerol, thymol, turmeric oleoresin, and curcuminoids. Of course, mixtures of at least two of these compounds and/or extracts can be used, in any proportion.

In ruminants (cows, sheep, and goats), plant extracts have been used to modify the microbial flora of the rumen directly. In effect, these plant extracts have well-known antibacterial properties. In ruminants, they alter the microbial equilibrium of the rumen ecosystem in order to optimize rumen fermentation and, accordingly, increase the milk and meat production. In effect, altering the microflora allows for the production of a volatile fatty acid that is energetically more effective (propionic acid) than what is normally most abundant (acetic acid).

The beneficial effect of these microbial changes on the animal's production in response to the incorporation of plant extracts released primarily in the rumen is well documented.

Furthermore, it has been observed that the release directly into the abomasum or rennet stomach, past the rumen, of these plant extracts causes a strong inflammatory reaction and decreases zootechnical performance in ruminants (production of meat or milk). This observation eliminates the benefit of the use of plant extracts in ruminants outside of a direct effect on the rumen ecosystem.

The inventors have shown that these compounds are also active past the rumen and, moreover, at much lower doses. This discovery makes it possible to use much smaller quantities of plant extract compared to what has been done until now to obtain a performance improvement in ruminants relative to traditional applications in the past with this type of compound.

The feed additive (undiluted by the addition of an inert medium) can be added to the animal's food intake, in a range of 0.01 to 2500 mg per kg of feed and/or 1 to 1000 mg/head/day.

The invention applies to all ruminants, particularly cattle, sheep, and goats.

Examples of the zootechnical performances that the invention can improve include milk production, milk quality, altered milk composition, altered feed consumption, altered eating behavior, improved average weight gain, increased food efficiency, improved insulin sensitivity of the digestive system, improved digestive health, and improved immunity.

### EXAMPLE 1

This example illustrates the method for preparing the feed additive according to the preferred embodiment of the invention described above, using plant extracts as an example.

### Point a)

Two non-nutrients are chosen that are plant extracts contained in oleoresin capsicum. These are capsaicin and dihydrocapsaicin (hereinafter “CDC”).

### Point b)

Method I is applied to the breakdown of CDC in the rumen.

The results of this study lead to:
a chromium disappearance rate=0.24
a CDC disappearance rate=1.2

DRNN-P=100−(0.24÷1.2)×100=80%

### Point c)

The obtained DRNN-P is 80%. This is higher than the DRNN-P threshold value (40% or 30%). Therefore, the plant extract is broken down in the rumen, and so we move to point e).

### Point e), f), g)

At least one coating compound is chosen, which is hydrogenated rapeseed oil. The plant extracts are coated according to the method described in international application EP2088871 (US20100055253; WO2008062368). This is cold atomizing, which makes it possible to coat or encapsulate 22% oleoresin capsicum in a matrix of 78% hydrogenated rapeseed oil.

We can proceed as follows. The oleoresin capsicum is incorporated into a matrix of hydrogenated rapeseed oil, whose melting point is between 66 and 72° C. The first particles are then produced using a cold atomizing system. The oleoresin capsicum content of these first particles is between 18 and 22%, with a target of 20%.

The density of these particles is between 0.40 and 0.52 g/cm³, their melting point is greater than 58° C., and their average size is between 400 and 600 microns. 85% of these particles are between 200 and 1000 microns in size.

These particles are then coated with palm oil, whose melting point is about 58° C.

The end product thus obtained has a density of around 0.5 g/cm³. It is comprised of particles, of which 85% are between 400 and 1600 microns.

This product is called NR/NN1.

### Point h)

Method II is applied to the NR/NN1 product, which leads to the following results:

CDC present in the product at the start=0.06 g

CDC present in the product after 6 hours=0.007 g

DRNN-E=((0.06−0.007)÷0.06))×100=88%.

### Point i)

The DRNN-E result is above the threshold value (60%). We return to point e).

### Points e) f) g)

To increase the release of non-nutrients (CDC here) past the rumen, another product is developed and made in two steps. The previously described product NR/NN1 (22% oleoresin capsicum in a matrix of 78% hydrogenated rapeseed oil) forms a core that is coated by means of a cold atomizing method with a 30% palm oil matrix. The result is NR/NN2, which contains 15.4% oleoresin capsicum.

### Point h)

Method II is applied to the NR/NN2 product, which leads to the following results:

CDC present in the product at the start=0.045 g

CDC present in the product after 6 hours=0.02 g

DRNN-E=((0.045−0.02)÷0.045))×100=55%.

### Point i)

The DRNN-E result is below the threshold value (60%). NR/NN2 is adopted for preparing particles to be used as a feed additive.

### EXAMPLE 2

This example illustrates the efficiency of the feed additive according to the invention on the zootechnical performance of dairy cows.

The effect of the NR/NN2 product on animal performance has been determined on Holstein dairy cows receiving a feed without product or a feed with 100 mg per day of NR/NN2 providing 15.4 mg/day of oleoresin capsicum. It should be noted that this dose if very low in comparison to the feed consumption of about 30 kilograms of dry matter per day in dairy cows, because it corresponds to a 0.5 ppm content relative to the daily food intake.

The results are shown in the following table:

| | Treatment¹ | | |
|---|---|---|---|
| | Control | NR/NN2 0.5 ppm | P Value |
| Ingested dry matter, kg/day | 29.1 | 30.0 | 0.22 |
| Milk production kg/day | 41.1 | 44.6 | 0.02 |
| Feed efficiency, kg/kg² | 1.41 | 1.49 | <0.01 |

¹Control, 0 mg/day NR/NN2; NR/NN2 100 mg/day of protected rumen capsicum product (15.4% oleoresin capsicum)
²Milk production ÷ Ingested dry matter

It is observed that the incorporation of NR/NN2 into the diet improves milk production and feed efficiency. The quantity of dry matter consumed is unaffected.

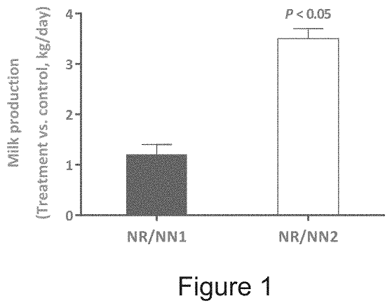

A similar test was carried out with NR/NN1 with 7.3 ppm oleoresin capsicum. The production results in response to NR/NN1 and NR/NN2 were compared in FIG. 1.

It is clear from FIG. 1 that the product protected from release/breakdown in the rumen, NR/NN2, is significantly more effective for increasing milk production and feed efficiency than product NR/NN1.

The inventors were surprised to observe that the 0.5 ppm of oleoresin capsicum provided by NR/NN2 are much more effective for increasing milk production and feed efficiency than the 7.3 ppm of oleoresin capsicum provided by NR/NN1, despite a dose that is about 15 times lower.

### EXAMPLE 3

This example illustrates that the effect of the feed additive according to the invention on the zootechnical performance of dairy cows is the result of a non-nutritional response. Specifically, the example shows that the effect is controlled by a hormonal response to the NR/NN2 product.

The effect of the plant extracts was generally evaluated based on their antimicrobial effect and their ability to alter rumen fermentations for the ruminant's benefit.

To understand how, despite a dose that is 15 times lower, NR/NN2 is nearly 5 times more effective for milk production than NR/NN1, the inventors tried to understand the mechanisms underlying this response.

The effect of the NR/NN2 product on energetic metabolism is determined on Holstein cows exposed to a glucose tolerance test. Glucose was injected intravenously, and 10 samples of blood were collected over a period of 110 minutes and then analyzed for the glucose and insulin content in the serum. The results are grouped in the following table:

| | Treatment¹ | | |
|---|---|---|---|
| | Control | NR/NN2, 0.5 ppm | P Value |
| Glucose_{0-110 min}, mg/dL | 133 | 126 | 0.17 |
| Insulin_{-110 min}, μIU/mL | 32.9 | 21.4 | 0.16 |
| Insulin ASC², μIU/mL*min | 1762 | 1249 | 0.04 |

¹Control, 0 mg/day NR/NN2; NR/NN2 100 mg/day of protected rumen capsicum product (15.4% oleoresin capsicum)
²Area under the curve

The results indicate that NR/NN2 increases insulin sensitivity, as shown by the increased rate by which glucose disappears and the reduced concentrations of insulin in the serum.

This demonstrates that providing a non-nutrient past the rumen can improve zootechnical production without a direct nutritional effect. Here, the response is partially controlled by a hormonal response.

### EXAMPLE 4

This example illustrates that the effect of the feed additive according to the invention on the zootechnical performance of dairy cows is the result of a non-nutritional response. Specifically, the example shows that the effect is controlled by an immune response to the NR/NN2 product.

The effect of the NR/NN2 product on the animal's immunity is determined on Holstein cows exposed to lipopolysaccharides (LPS) in order to mimic an Escherichia coli infection. For the test, LPS (Escherichia coli 0111:B4; 1.0 μg/kg animal weight) was dissolved in 100 ml of sterile saline solution at 0.9%. The solution was injected into the jugular vein at a rate of 1 ml/min using a sterile tube with peristaltic pumps for 100 min. Milk production was measured twice daily for 6 days, and the blood samples were collected 0, 2, 4, 8, and 24 hr after the injection. The results are shown in the following table:

| | Treatment¹ | | |
|---|---|---|---|
| Milk production kg/day | Control | 0.5 ppm NR/NN2 | P Value |
| Before exposure to LPS | 41.1 | 44.6 | 0.02 |
| Day 2 after exposure to LPS | 26.0 | 30.0 | <0.05² |
| Day 6 after exposure to LPS | 34.2 | 37.2 | <0.05² |
| Serum cortisol, μg/dL | 4.23 | 2.98 | 0.03 |

¹Control, 0 mg/day NR/NN2; NR/NN2 100 mg/day of protected rumen capsicum product (15.4% oleoresin capsicum)
²Treatment interaction * day

It is observed that the production of milk after the exposure was reduced in the groups of animals with or without NR/NN2. However, the cows supplemented with NR/NN2 had a faster reestablishment.

The serum cortisol level decreases with a diet that includes NR/NN2, indicating that the animals responded better to this exposure.

These mechanism studies reveal that, contrary to what might be expected, non-nutrients (plant extracts here) released past the rumen are capable of interacting directly in a non-nutritional manner with the metabolism and immunity of the animal. This direct interaction allows for a considerable improvement in the efficiency of the product.

1. A feed additive comprising:
at least one non-nutrient that is oleoresin capsicum, which non-nutrient is incorporated in a matrix that comprises hydrogenated rapeseed oil, wherein the matrix comprising the incorporated non-nutrient is encapsulated by a coating comprising palm oil.

2. A feed additive according to claim 1, wherein the feed additive is in the form of particles and 85% by weight of the particles have a size ranging from 400 to 1600 microns.

3. A feed additive according to claim 1, wherein the feed additive is in the form of particles and the matrix comprising the incorporated non-nutritent makes up 0.5% to 70% by weight of the particles and the remainder comprises the coating.

4. A feed additive according to claim 6, wherein the feed additive is in the form of particles and 85% by weight of the particles have a size ranging from 400 to 1600 microns.

5. (canceled)

6. A feed additive according to claim 1, in which wherein the non-nutrient content of the feed additive is at least 5% and at most 70% by weight.

7-20. (canceled)
